(19) United States
(12) Patent Application Publication
(10) Pub. No.: US 2010/0125872 A1
(43) Pub. Date: May 20, 2010

(54) System and Method for Actively Programming Aggregated Media On-Demand Networks

(76) Inventors: James J. Crow, Austin, TX (US); Kip R. McClanahan, Austin, TX (US)

Correspondence Address: HAMILTON & TERRILE, LLP, P.O. BOX 203518, AUSTIN, TX, 78720, US

(21) Appl. No.: 12/272,330

(22) Filed: Nov. 17, 2008

(51) Int. Cl. H04N 7/10; H04N 7/173

(52) U.S. Cl. 725/35; 725/87

(57) ABSTRACT

A method, apparatus and system for programming media content on an aggregated media on-demand network are provided which models the MoD network by identifying a plurality of distribution channels that provide media content to a plurality of targeted consumers associated with a specified passion area and generating consumer profile information for the plurality of targeted consumers. As distribution rights over the MoD distribution channels are established and performance parameters for the MoD network are measured, the MoD network may be programmed with media content based on the consumer profile information for the plurality of targeted consumers, the performance parameters for the aggregated media on-demand network, and content profile information for the media content.

### BACKGROUND OF THE INVENTION

1. Field of the Invention

The present invention relates generally to content delivery systems. In one aspect, the present invention relates to a system and method for programming media use by positioning content in a predetermined way.

2. Description of the Related Art

Video on Demand (VoD) and Media on Demand (MoD) both refer to an interactive multimedia system whereby the user/customer is able to choose digital media content (for example, a movie or television show) from a media database for viewing. Examples of MoD content include, but are not limited to, video, local news and weather forecast programs, games, music, educational content, home shopping, and other consumer service content. While the underlying technologies have not been standardized, the main components of a video on demand service are shown in FIG. 1. As depicted, a video server (10, 11) is provided for controlling access to video content stored on one or more video database storage devices (12, 13). The video server (e.g., 10) is connected to the data delivery network 14, which in turn is connected to one or more subscriber devices 2-7 which may be configured to select and view video content over the network 14. Examples of subscriber devices include, but are not limited to, personal data assistant devices 2, cell phone devices 3, 7, computer devices 4-5, and television devices 6 which may be connected directly to the network 14 via a set-top box (not shown) for interfacing the television equipment with the MoD content. In operation, video programs stored in a video server 10 may be transmitted in a coded, compressed format when ordered by a subscriber (e.g., 2). Upon receipt at the requesting subscriber, the video data is decoded and decompressed for playback.

MoD networks have proliferated to allow users to select and watch/listen to video or audio content on demand across online networks, traditional television channels, as well as mobile devices. Historically, media content, alone or in combination with advertising content, could only be generally presented to viewers using ratings data as the primary criteria so as to catch the attention of prospective viewers/customers and induce those viewer/customers to view/consume the content/advertisement. However, this conventional, untargeted approach of distributing media content can fail to attract the attention of the intended audience. Even with interactive MoD systems which employ user-entered data to choose content for presentation to the user, such systems are not able to present content in such a way as to effectively leverage user profile or affinity information. In addition, with the existing MoD networks, users must actively search for media content by visiting locations on the network where the user expects to find the desired content, making it difficult, if not impractical, with conventional content delivery mechanisms to deterministically drive users to discover media and align media offerings to consumption patterns and affinities. As a result, there is no way to effectively program the delivery of on-demand digital media content to the target users.

Accordingly, there is a need for improved system and methodology for programming the delivery of MoD content to overcome the problems in the art, such as outlined above. Further limitations and disadvantages of conventional approaches will become apparent to one of skill in the art after reviewing the remainder of the present application with reference to the drawings and detailed description which follow.

### SUMMARY OF INVENTION

A system and method are provided for programming digital media use by positioning digital media content on predetermined, optimized distribution channels that are characterized with reference to desired consumer/user profiles. By characterizing a large set of media-on-demand (MoD) distribution channels, modeling all channels and consumers into a system of numerical analysis to identify one or more media-on-demand distribution channels that provide media content to a plurality of targeted consumers, establishing distribution rights over the identified channels (either by negotiating a business relationship or building out new distribution channels), and applying a deterministic process to actively program content into these networks, it is possible to achieve directed engagement and highly optimized delivery of digital media content. In accordance with selected embodiments of the present invention, MoD networks may be actively programmed using separate processes for modeling the network, building out the network, measuring the network, programming the network, and then visualizing the network. These processes represent a phased system of understanding, measurement, and ultimately direct control of on-demand networks in such a way as to provide value for all constituents within the MoD value chain. Media producers gain from a more engaged and attentive audience, advertisers and sponsors gain from alignment of demographic to products and brand, and content distributors benefit from increased quality of media offerings to their chosen audience. The consumers also benefit from the enriched media programming that replaces the flat, disorganized offerings of today.

In other embodiments, a method and system are provided for programming media content on an aggregated media on-demand network. As a preliminary step, an aggregated media on-demand network is modeled by identifying media-on-demand distribution channels that provide media content to targeted consumers associated with a specified passion area and generating consumer profile information for the targeted consumers. In an example embodiment, the modeling involves identifying a passion area of one or more market segments representing a target market demographic, modeling the targeted consumers with a first standardized data template to provide a numerical representation of the consumer profile information for the targeted consumers, modeling the media-on-demand distribution channels with a second standardized data template to provide a normalized numerical representation of the media-on-demand distribution channels, and modeling a media content program with a third standardized data template to provide a numerical representation of the content profile information for the media content. Distribution rights are then established over the media-on-demand distribution channels for the aggregated media on-demand network, such as by negotiating a business relationship which allows media content to be provided over, and performance measures to be acquired from, the media-on-demand distribution channels, and/or by creating new and unique channels of distribution that are aligned with the targeted audience and/or consumption requirements. In addition, performance parameters are measured for the aggregated media on-demand network, such as by instrumenting the media-on-demand distribution channels for statistics and transactional event data. The performance parameters measured from the aggregated media on-demand network may then be aligned along one or more predetermined dimensions for use in performing online analytical processing queries. Finally, the aggregated media on-demand network is programmed with media content based on the consumer profile information for the targeted consumers, the performance parameters for the aggregated media on-demand network, and content profile information for the media content. In selected embodiments, network programming involves selecting media content for distribution through the media-on-demand distribution channels by matching the content profile information for the media content with the consumer profile information for the targeted consumers and the performance parameters for the aggregated media on-demand network. As part of the programming operations, an analytics console may be used to display the consumer profile information for the targeted consumers, the performance parameters for the aggregated media on-demand network, and content profile information for the media content.

In other embodiments, a digital media programming system and apparatus are provided which include a centralized network programming server that is communicatively coupled to a plurality of media outlet servers for actively programming digital media programs on a media-on-demand network. The programming server includes a data storage device which stores one or more digital media programs, content profile information for each digital media program specifying one or more characteristics of a targeted consumer of the digital media program, network performance measurement data for each of the plurality of media outlet servers, and consumer profile information for one or more targeted consumers. In addition, the programming server includes a network modeling module that is configured to model a first media on-demand network by identifying a first distribution channel comprising a first group of media outlet servers that provide digital media programs to a first group of targeted consumers for a first consumer interest area. The first media on-demand network may be modeled based on the consumer profile information for the first group of targeted consumers, the network performance measurement data, and content profile information for the one or more digital media programs, where any of the consumer profile information, network performance measurement data, or content profile information may be aligned along one or more predetermined dimensions for use in performing online analytical processing queries. In addition, the network modeling may also use standardized data templates to provide a normalized numerical representation of the consumer profile information, the media outlet servers and/or the content profile information. The programming server also includes a content programming module for programming the first group of media outlet servers in the first distribution channel with one or more digital media programs based on the model of the first media on-demand network. In operation, the content programming module selects one or more digital media programs for distribution through the first group of media outlet servers in the first distribution channel by matching the content profile information for each digital media program with the consumer profile information for one or more targeted consumers and the network performance measurement data for each of the plurality. The digital media programming system may also include a data collection server which collects and records network performance measurement data in a normalized form from the plurality of media outlet servers for delivery to the centralized network programming server.

In still further embodiments, a computer-implemented method and apparatus for actively programming aggregated media on-demand networks are provided for identifying and programming media-on-demand distribution channels with digital media programs based on identified programming parameters. As disclosed, the identified programming parameters may include content profile information for each digital media program specifying one or more characteristics of a consumer of the digital media program, consumer profile information for one or more consumers, and/or network performance measurement data for each of a plurality of media outlet servers. Based on the programming parameters, one or more media-on-demand distribution channels are identified by selecting a group of media outlet servers which provide one or more digital media programs to one or more consumers associated with a specified consumer interest area. This may be done by aligning network performance measurement data, content profile information, and consumer profile information along one or more predetermined dimensions for use in performing online analytical processing queries. Finally, a first digital media program is placed at a media-on-demand distribution channel for on-demand delivery to consumers who access the media-on-demand distribution channel, where the content profile information for the first digital media program matches at least in part the consumer profile information for the one or more consumers associated with the specified consumer interest area for the media-on-demand distribution channel.

### BRIEF DESCRIPTION OF THE DRAWINGS

The present invention may be understood, and its numerous objects, features and advantages obtained, when the following detailed description is considered in conjunction with the following drawings, in which:

FIG. 1 illustrates the main components of a video on demand system;

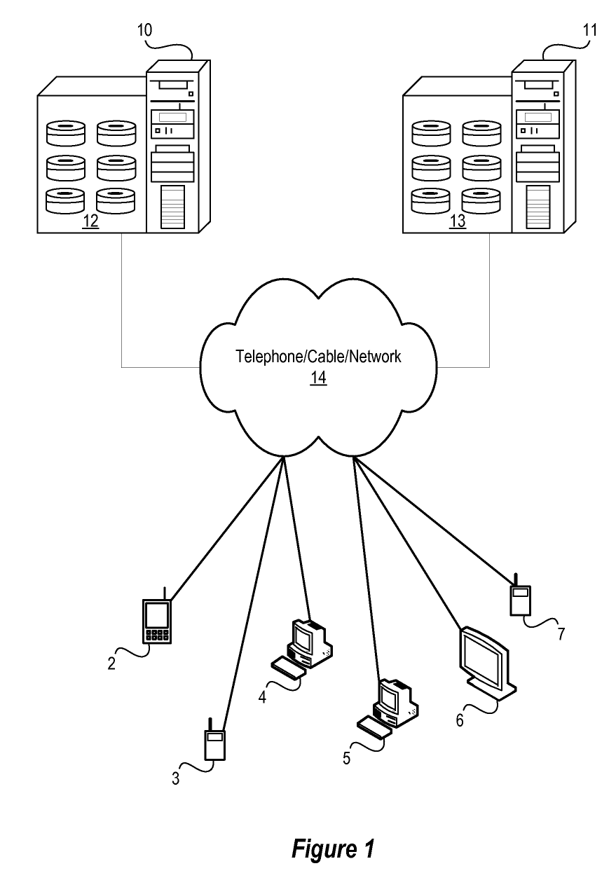

FIG. 2 illustrates an exemplary flow diagram of the media programming methodology according to selected embodiments of the present invention;

FIG. 3 illustrates a schematic block diagram of an illustrative MoD network programming system that may be deployed to actively program aggregated media-on-demand networks; and

FIG. 4 illustrates an example analytics console user interface which is used to visualize the MoD network for purposes of actively programming media content.

It will be appreciated that for simplicity and clarity of illustration, elements illustrated in the drawings have not necessarily been drawn to scale. For example, the dimensions of some of the elements are exaggerated relative to other elements for purposes of promoting and improving clarity and understanding. Further, where considered appropriate, reference numerals have been repeated among the drawings to represent corresponding or analogous elements.

### DETAILED DESCRIPTION

A system and method are described for actively programming aggregated digital media on-demand networks. In selected embodiments, media content is effectively programmed for selection and viewing by targeted users by modeling targeted users and MoD distribution channels into a system of numerical analysis, and then applying a deterministic process to actively program content into these networks to achieve directed engagement and highly optimized delivery. In selected embodiments, MoD networks are actively programmed by first modeling the network to identify consumer passion areas and associated distribution channels used by targeted users to access the passion areas. As will be understood by those skilled in the art, a passion area refers to a specific topic or subject matter area of interest for users who will actively seek out digital media content or other information relating to the topic or subject matter area. With the passion areas and associated distribution channels identified, the network is built out by entering into a business relationship with selected distribution channel(s) and/or by creating distribution outlets along the desired audience requirements. In this manner, a large network of media distribution is created with specific audience demographic, psychographic, and consumption behavior defined in quantifiable terms. Once the network is built out, it may be measured across a plurality of aligned dimensions to determine the performance of the network in terms of delivery, consumption patterns. In addition, the network may be programmed by creating, acquiring or tailoring content for deployment across the distribution channels to the targeted users in the identified passion area(s). Over time, transaction and consumption data from the network is monitored and analyzed to track the network performance so that adjustments in the network configuration and programming may be made. With these processes, a phased system of understanding, measurement, and direct control of on-demand networks is provided so that media producers and advertisers are able to reach a more engaged, attentive and demographically aligned audience, and consumers obtain access to enriched media programming.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms or operations on data within a computer memory. Such descriptions and representations are used by those skilled in the art to describe and convey the substance of their work to others skilled in the art. It is also noted that, throughout this detailed description, certain aspects of the invention are described with reference to a computer-based system wherein a processor executes algorithms embodied in data and/or software instructions. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

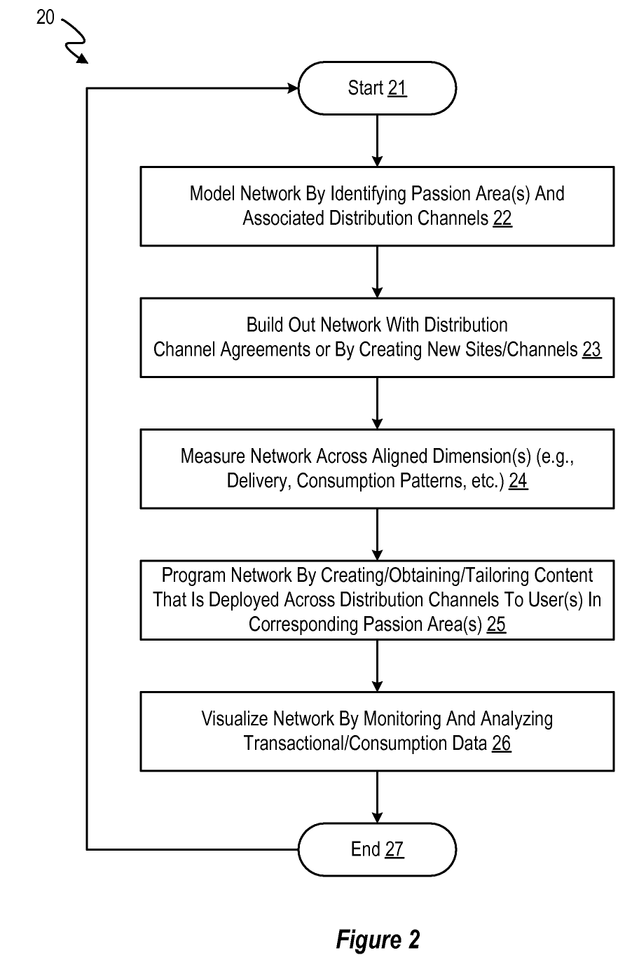

Turning now to FIG. 2, there is shown an exemplary flow diagram of the media programming methodology 20 according to selected embodiments of the present invention. As illustrated with the example of FIG. 2, after the programming methodology begins (step 21), a network modeling process (step 22) is used to identify one or more audience passion areas for digital media consumption, where the modeling process also identifies one or more distribution channels or endpoints (e.g., websites, VoD channels, mobile video channels, etc.) where content relating to the passion area is consumed. The network modeling process may use market analysis to determine or identify passion areas that represent the desired market demographic and/or psychographic target for the desired users. A passion area may be defined with reference to multiple consumer segments that are individually defined, or alternatively, multiple segments may be aggregated into a single target passion area that represents a combination of individual segments. The network modeling process may also identify consumers that fall within a defined passion area by modeling the consumers with a standardized data template that allows numerical representation and analysis of the characteristics of the consumer demographic. Likewise, when identifying distribution channels that correspond to the defined passion area, the distribution channels may be modeled in a standardized way such that the distribution network is normalized and numerical analysis is possible. The network modeling process may also identify other information pertaining to the consumers and distribution channels associated with the passion area, such as the audience size for a given distribution channel, the format requirements for the distribution channels, the update and control requirements for distributing content over the distribution channels, etc.

After the modeling the network, a network build out process (step 23) is used to obtain distribution rights in the identified distribution channels. The network build out process identifies or selects individual, actual distribution channels based upon each individual channel's contribution to meeting the goals of the market model created in the network modeling process. Once the distribution channels are selected for a given passion area, the content distribution company or programming entity enters into a business relationship to obtain access to the distribution channels. For example, distribution channel agreements may be negotiated and entered which allow content to flow freely through that channel as defined by the company, and which allow the content distribution company to capture detailed and specific information about each distribution channel and the consumers behind/within that channel. In this way, the content distribution company can capture information is entered into an analytics database. Each of these channels will be instrumented as deeply as possible for statistics and transactional event data that are collected into an analytics data warehouse. In building out the network with distribution channels, the type of distribution provide by each channel should be monitored and tracked. For example, certain distribution partners (e.g., Youtube) provide a horizontal distribution function in that the content distributed by such partners has no thematic or subject matter focus, while other distribution partners (e.g., Golf.com, RobbReport.com) provide a vertical distribution function in that the content distributed by such partners has a thematic or regional focus. Over time, the number and variety of distribution channels or endpoints are increased to expand the size of the distribution network.

In addition or in the alternative to the foregoing, the modeling process 22 may be used to identify gaps in the current available spectrum of existing distribution channels. Once any gaps have been identified, the network build-out process 23 may be used to create new distribution channels (e.g., a new theme-based web site) that meet the requirements of the desired audience and consumption model in the identified gap. For example, one or more boutique sites may be built that are narrowly aligned with a desired audience/demographic that is not being served by existing (third party) sites and channels. In this scenario, a content distribution company or programming entity builds, owns and operates the new distribution channels and sites, thereby investing in audience generation that can be leveraged in the distribution network. An example of such as site is at www1.oncooking.tv which was developed and built out by ON Networks, Inc. As the creator of the new distribution channels and sites, the content distribution company or programming entity is able to defined and control the flow of content through the channels/sites, and can also capture detailed and specific information about each distribution channel/site and the consumers behind/within that channel for entry into an analytics database. In addition, the new distribution channels and sites can be deeply instrumented, monitored and tracked by the content distribution company or programming entity for statistics and transactional event data that can be collected into an analytics data warehouse.

After building out the network to the point where there are sufficient (e.g., hundreds) individual distribution channels engaged, the network performance may be assessed with a network measurement process (step 24) whereby the aggregated network is measured across several dimensions to assess performance parameters for the network, such as delivery, consumption patterns, etc. The measurement process may collect data measurements from the distribution channels that are defined and determined by numerical analysis of the profile information for each channel, and that are aligned in such a way as to provide value. For example, the measurements may be aligned by demographic or consumer affinity. In addition or in the alternative, alignment by accessibility or cost to acquire and/or serve is also useful. The measurement process may also be used to collect data on sub-networks within the larger network where each sub-network is a group of individual channels that are aligned by some market specific quality.

Based on the network modeling process (step 22), build out process (step 23) and measurement process (step 24), the network may be programmed (step 25) by creating, acquiring or tailoring content that is deployed across the identified distribution channels to the targeted consumers associated with the desired passion areas. In other words, the programming process (step 25) uses the information generated by processes 22-24 to directly program media content into the identified (sub)networks with a high degree of predictability. By increasing the size of the underlying network (steps 22-23), identifying and measuring the specific alignment factors that support marketing and consumption patterns (step 24), and grouping of the distribution channels into leveragable units (steps 22-23), media distribution campaigns can be created in the network programming process (step 25) that are optimized around directly reaching the desired consumer base while minimizing distribution friction and waste. The programming process can be used to match content programs with demographically aligned distribution channels/endpoints and consumers, but can also be used to match advertising content with demographically aligned content, distribution channels/endpoints and consumers.

To monitor and analyze the transactional and consumption data generated by the network, a highly versatile user interface is provided for visualizing and/or directly manipulating the measured network data (step 26). As described more fully hereinbelow, the user interface will provide both query and/or filter creation, as well as data visualization and presentation. The purpose of the user interface is to provide true research-oriented analysis based upon “what if” questions. In addition, the user interface provides polished and packaged “finished goods” in the form of reports, data tables, and other deliverable data packets.

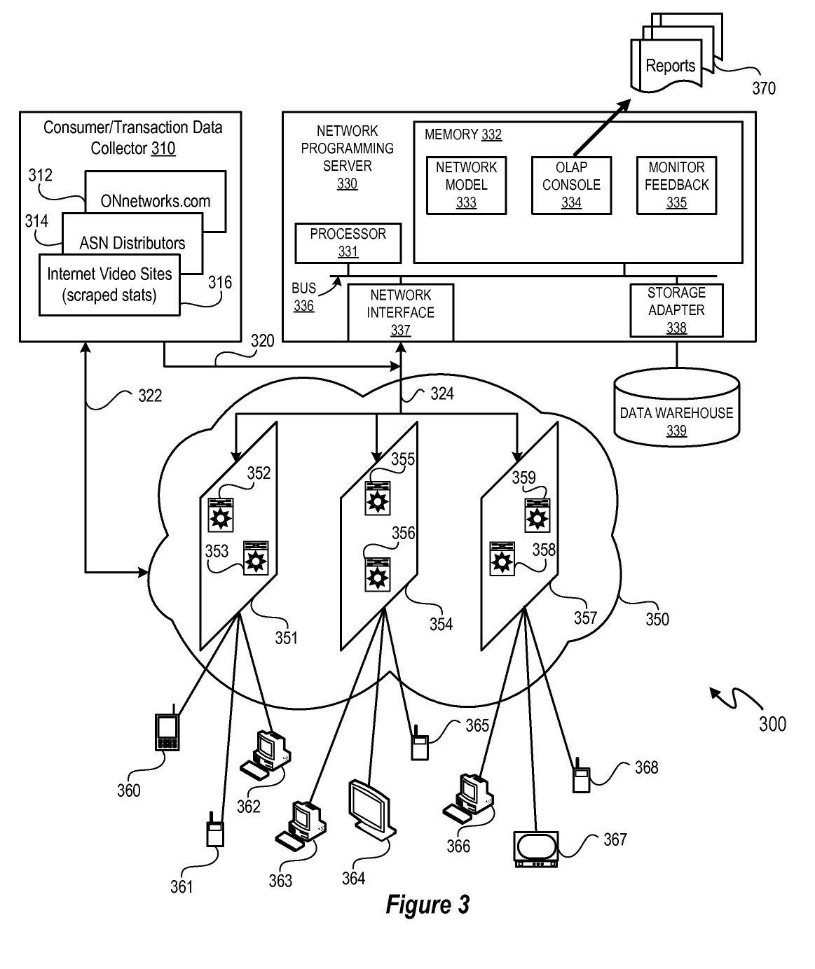

FIG. 3 illustrates a schematic block diagram of an illustrative MoD network programming system 300 that may be deployed to actively program aggregated media-on-demand networks. The system 300 includes a network programming server 330 which can be implemented on a computer system such as a general-purpose server computer which characterizes or models a large set of MoD distribution channels in a communication network 350 into a system of numerical analysis so that content can be actively programmed for presentation and selection by targeted viewers 360-368 to achieve directed engagement and highly optimized delivery. To assist with the modeling and monitoring of the network performance, the programming system 300 also includes a data collection mechanism 310 which collects and records information in a normalized form that is provided to the server 330. Thus, the process for disclosed programming system 300 may be implemented with connected and integrated computer systems and workflows that define and model information at an abstract level, collect and record information in a normalized form.

In selected embodiments, the network programming server 330 generally includes one or more CPU/processors 331, a main memory 332, and a mass storage 339, all coupled to one or more bi-directional system busses 336 along with input/output devices (not shown), such as a keyboard and/or mouse. The processor 331, in one embodiment, is a 32-bit or 64-bit microprocessor manufactured by Motorola (such as the 680×0 processor), by Intel (such as the 80×86, or Pentium processor), or by IBM. However, any other suitable single or multiple microprocessors or microcomputers may be utilized. Computer programs and data are generally stored as instructions and data in mass storage 339 until loaded into main memory 332 for execution. Main memory 332 may be comprised of dynamic random access memory (DRAM). The mass storage device 339 may include both fixed and removable media which may be implemented with mass storage technology, such as a magnetic disk, or in a redundant array of storage mediums. Bus 336 may contain, for example, 32 address lines for addressing main memory 332. The system bus 336 may also include, for example, an n-bit data bus for transferring data between and among the components, such as CPU/processors 331, main memory 332, and mass storage 339, where “n” is, for example, 32 or 64. Alternatively, multiplex data/address lines may be used instead of separate data and address lines. The CPU/processor(s) 331 may be connected directly (or through an interface or bus) to a variety of peripheral and system components, such as a hard disk drive, cache memory, traditional I/O devices (such as display monitors, mouse-type input devices, floppy disk drives, speaker systems, keyboards, hard drive, CD-ROM drive, modems, printers), network interfaces, terminal devices, televisions, sound devices, voice recognition devices, electronic pen devices, and mass storage devices such as tape drives, hard disks, compact disk (“CD”) drives, digital versatile disk (“DVD”) drives, and magneto-optical drives. The peripheral devices usually communicate with the processor over one or more buses and/or bridges. The foregoing components and devices are used as examples for sake of conceptual clarity and that various configuration modifications are common.

To connect with external devices or networks, the network programming server 330 also includes peripheral interface devices, such as a network interface 337 and/or a storage adapter 338. The network interface(s) 337 contain the mechanical, electrical and signaling logic and circuitry for communicating data and control information over the network 350 coupled to remote user devices 360-368. For example, the network interface 337 may include a network interface card or device to provide a direct connection 324 to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface. The storage adapter 338 contains logic and circuitry for accessing applications, media content (e.g., video programs, advertisements, etc.) and other data stored in the attached data warehouse 339. The media content may be stored in the data warehouse 339 using any desired digital file formats and compression algorithms.

In the main memory 332 or data warehouse 339, program code and data structures are stored for execution and manipulation by the processor(s) 331. For example, the main memory 332 stores, among other things, computer-readable instructions and data for implementing network modeling software 333 that is configured to model the targeted consumers for different passion areas, as well as the distribution channels that are used to reach those targeted consumers. The data in the main memory 332 or data warehouse 339 that is used by the network modeling software includes one or more digital media programs, content profile information for each digital media program specifying one or more characteristics of a targeted consumer of the digital media program, network performance measurement data for each of the plurality of media outlet servers, and/or consumer profile information for one or more targeted consumers. With this data, the network modeling component 333 implements a modeling process in which a passion area corresponding to a desired market demographic is defined with reference to one or more individual or aggregated market segments. In addition, the network modeling component 333 models the consumers with a standardized data template that allows numerical representation and analysis of the characteristics of the demographic. The network modeling component 333 also models the distribution channels associated with each defined passion area in a standardized way such that the distribution network is normalized and numerical analysis is possible. In the network modeling component 333, the media content is also modeled or profiled in terms of its characteristics or descriptive parameters that will be used to actively program the media content. For example, media content stored in the data warehouse 339 may include content profile information which specifies the targeted consumer characteristics (e.g., targeted age group, gender, geography, buying habits, and so forth). Finally, the network modeling component 333 is configured to program selected media outlet sites with selected digital media content (e.g., video programs, advertisements, etc.) from the attached data warehouse 339 that is distributed over the identified distribution channels to reach the targeted consumers associated with the passion area based on the consumer profile information for targeted consumers, the performance parameters for the aggregated media on-demand network, and content profile information for the digital media content. The content selection process may be driven, at least in part, by the modeled profile information for the targeted consumers, as well as the programming those consumers are engaged with and the platforms that the programming is engaged with.

To provide an illustration of how media content may be actively programmed over the aggregated MoD network 350 to reach a targeted set of consumer devices, the network modeling software 333 effectively separates the communication network 350 into a plurality of distribution channels 351, 354, 357 with the distribution channel modeling function. Each defined distribution channel (e.g., 351) includes one or more media outlets (e.g., servers 352, 353) that have been identified as being sources for content that is consumed by the targeted consumers (e.g., devices 360-362) in a specified passion area. Thus, if “fashion” is identified as a passion area for a particular set of targeted consumers (e.g., 363-365), the network modeling software 333 identifies a distribution channel 354 which includes media outlets 355, 356 for reaching the set of targeted consumer devices 363-365. While this example is provided with reference to a desktop computer 363, television 364 and mobile phone 365, it will be appreciated that any type of interactive media playback device can be used for the consumer devices, including but not limited to mobile devices (e.g., iphone), cell phones, web pages, video-on-demand platforms, televisions, desktop computers, laptop computers, TIVO, Apple TV units, etc. Of course, for other passion areas (e.g., “sports”) that appeal to a different set of targeted consumers (e.g., 366-368), the network modeling software 333 identifies a different distribution channel 357 which includes media outlets 358, 359 for reaching the set of targeted consumer devices 366-368.

For each targeted consumer device in a specified passion area that is coupled over the network 350 to the network programming server 330, the network modeling software 333 may perform various predetermined statistical or numerical analyses to select which media content (e.g., video programs, advertisements, etc.) should be loaded from the data warehouse 339 and forwarded over the network 350 to the targeted consumer device(s). The network modeling software 333 may aggregate consumer and transaction data received from the targeted consumer devices and distribution channels, analyze the aggregated data to identify various consumption and demographic trends, compare the results of the data analysis to content profile information, and select content which is “targeted” to the identified customer demographics based on the comparison results.

To assist with content programming, the main memory 332 or data warehouse 339 may also include program code and data structures for monitoring feedback 335. In accordance with the illustrative embodiment, the feedback monitor component 335 monitors the performance of the aggregated network of distribution channels across one or more dimensions, such as delivery, consumption patterns, etc. In addition or in the alternative, the feedback monitor component 335 may monitor and store consumer statistics and data about the people, or personas, who engage with the MoD programming, about the programming those people are engaged with, and about the platforms that the programming is engaged with≠either a particular distribution network or potentially a literal screen or device. In selected embodiments, the feedback monitor component 335 may organize the consumer statistics and data into a normalized format, and may align the consumer statistics and data in such a way as to provide value. For example, the data can be aligned by demographic, by consumer affinity, by accessibility or by cost to acquire and/or serve.

While the consumer statistics and data can be fed back directly by the targeted consumer devices 360-368, the MoD network programming system 300 may also include a separate data collector 310 to collect consumer and transaction data concerning the content, consumer devices 360-368 and distribution channels 351, 354, 357. As will be appreciated, the data collector 310 may be implemented with any desired platform device, whether hardware, software or a combination of both. However implemented, the data collector 310 may be configured to provide content profile information from a content profile source 312 (e.g., ON Networks.com). In addition, the data collector 310 may be configured to measure and provide network performance data from a content distributor 314 (e.g., ASN Distributors). Finally, the data collector 310 may be configured to scrape statistics (e.g., content, viewership, comments, etc.) from Internet video sites 316, such as Youtube.com.

While the network modeling software 333 may be manually configured to associate which content should be presented to which consumer device, the main memory 332 or data warehouse 339 may also include program code and data structures for providing a programming console 334 which is used to analyze or visualize the MoD network for purposes of actively programming content thereon. In accordance with the illustrative embodiment, the programming console component 334 performs on-line analytical processing (OLAP) computations on the normalized and aligned transaction and/or consumption data. Once the consumer, content and distribution channel data is transformed into a normalized format, the transformed data may be translated under control of the console 334 into fact tables suitable for processing by analysis tools, such as OLAP. For example, using the processing functionality provided by one or more computer systems (e.g., network programming server 330), the transaction/consumer data is transformed into tables that can be used by common analysis tools (such as Microsoft's Analysis Services) to generate cubes that may be used to program the network with content that matches the distribution channels of the targeted consumers. The programming console component 334 is configured to perform both query and/or filter creation functions on the transformed data, as well as data visualization and presentation, thereby supporting the performance of research-oriented analysis based upon “what if” questions. Based on the analysis results, the programming console component 334 may be configured to generate reports, data tables, and other deliverable data packets 370.

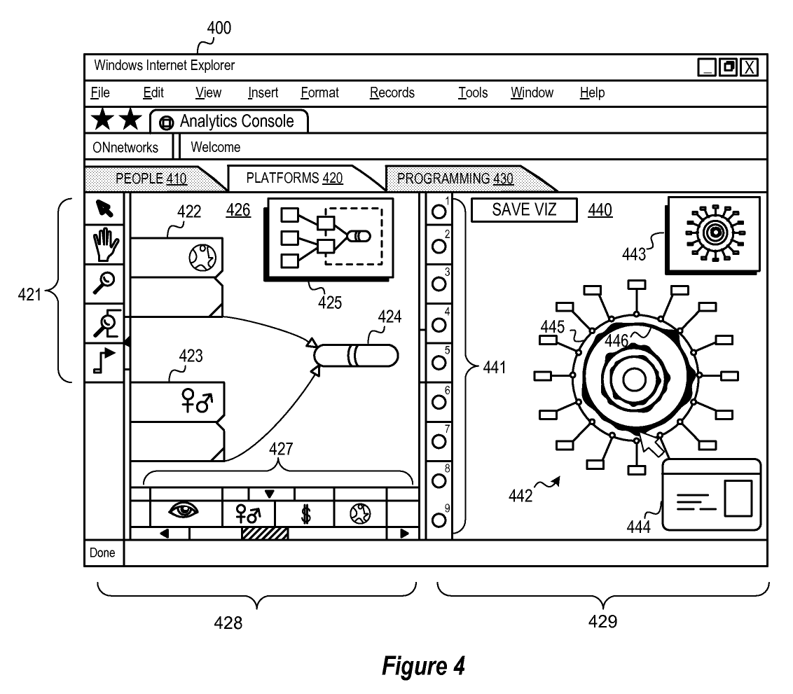

Turning now to FIG. 4, there is illustrated an example of the analytics console user interface 400 which may be generated by the network programming server 330 to visualize the MoD network for purposes of actively programming media content. In selected embodiments, the analytics console user interface 400 may display different tiers of information that may be used by an analyst engaged in MoD research to program the aggregated networks with media content. For example, the analytics console user interface 400 may display a first tier of information at tab 410 about the people, or personas, who consume the media content within the specified passion area. In an example embodiment, the first tier may provide a visual indication of the geographic location of the people by displaying a dot for each person on a geographical map to provide a heat or cluster map whereby small dots are placed on a map which eventually form “hot” or “clustered” areas to visually convey the location and “weight” of the audience.

At another tab 430, the analytics console user interface 400 may display a second tier of information about the programming those people are engaged with. In an example embodiment, the second tier may provide a visual indication of the programming content using a node-based constellation map in which each passion area of programming is represented with a variably sized circle shape. The scale or relative size of the circle shape corresponds to its popularity or level of engagement with the passion area genre. Proximity of passion area circles and their particular hue/tint/shade will represent the affinity of one passion area to another. Each program or show associated with a passion area is represented with dots that are connected to the associated passion area circle shape by a connecting line. Longer connecting lines mean that the show is older, while shorter lines mean that the show is newer.

And at a third tab 420, the analytics console user interface 400 may display a third tier of information about the platforms that the programming is engaged with, such as a particular distribution network or even a literal screen or device. In an example embodiment, the third tier may provide a visual indication of the available platforms or distribution channels using a ring of weighted points 442, where each distribution channel in the aggregated network is represented on an outer ring 445 with a point and an attached platform logo label. Concentric rings within the platform ring 442 represent different properties of a distribution platform, such as, for example, volume of content. In an example embodiment, the thickness of the inner ring 446 varies according to the “strength” of a particular platform point closest to that segment of the inner ring 446. If Verizon, YouTube, and Tivo were points on the outer ring 445, the inner concentric ring 446 would represent “volume of distributed content” by having a bulge closer to YouTube than Verizon if YouTube distributes more content than Verizon. As will be appreciated, different visual cues besides varying thickness can be used to represent characteristics of the weighted points. In addition, additional details concerning a platform point in the platform ring 442 can be provided in a pop-up window 444.

In addition to displaying assembled data on the people, platform and programming, the analytics console 400 includes application functionality which allows the creation of filters and/or other grouping or query parameters. These profiles are generated using specific guidelines, value thresholds, commonality and/or differences, etc. that can be computed and/or detected within the underlying data. These queries are then executed against the database and the results are displayed in a high-level visualization application that is tailored to present media and media consumption information. Before viewing or interacting with the visual representations of the data, the user needs a way to select and manipulate data pertaining to the programming objective. While semantic modules interfaces (such as used to set up email filters) can be used, selected embodiments of the present invention provide a composite tree data modeling interface for use in exploring the data.

FIG. 4 provides an example of a dataset modeling interface which may be used in the analytics console user interface 400 to display and manipulate the assembled platform data by employing a composite tree interface. Those skilled in the art will appreciate that composite tree interfaces have been developed in digital compositing applications for the visual effects industry, and use modules represented by a flowchart-like diagram to depict input imagery, operators (or effects) that perform manipulations on input imagery, and the results thereof. However, selected embodiments of the present invention use a composite tree such as shown in the first view port 428 of the analytics console user interface 400 which includes pre-defined modules or filter nodes (e.g., 422, 423) that can be dragged from a “bin” area 427 to a “build” area 426, and that can be manipulated with the tool icons 421 on the left side of the first view port 428. Each of the filter nodes or modules 427 represents a single field in a database table (e.g., gender, income, hobbies, etc.) that can be specified by the user with a value that acts as a filter to the larger input dataset. As modules are added to the composite tree, the user can set parameters within the operators to control the specific filtering or query functions performed by the module. When a user wishes to focus in on a particular set of data points in any of the tiers, the user builds a model of those data points by composing various filter modules together in a composite tree interface, and the modules are then applied to filter the assembled data on the people, platforms and programming, with the result being stored in a capsule 424.

After a capsule (e.g., 424) is complete, the user can visualize those data points within the unique map associated with the current tier (e.g., platform tier 420) by using a second view port 429 to display the visualization map 442. When both view ports 428, 429 are open, the user can slide the center divider as desired to size the two ports. In the second view port 429, the visualization map 442 (e.g., ring of weighted points) shows the available platforms or distribution channels as nodes no the outer ring 445, and also provides the user with interactive information. For instance, a user could hover the cursor over a platform icon which would bring up specifics of that particular platform in a pop-up window 444.

For the visualization maps in each view port 428, 429, users can zoom into a fine detail level, and can zoom out to a more comprehensive level. The zoom levels allow users to comprehend their data set from a broad perspective as well as gather specific knowledge about their data. To facilitate the zoom functionality, each visualization map may have a corresponding navigator interface window 425, 443 on the top right corner. The interaction for the navigator interface 425, 443 shows a dashed box around a particular area of the map so that the area of the map within the dashed box is what is displayed in the main area in the center of the view port. Users can navigate the overall space by dragging this box within the boundaries of the navigator interface. In addition to the navigator interface, users can pan around either view port by selecting the hand tool on the applications tool bar on the right. In the pan mode, users simply click-and-drag around the viewport.

The computer-based methods and systems for actively programming aggregated media on-demand networks as shown and described herein may be implemented in software with any type of computer system or programming or processing environment, or in a computer program, alone or in conjunction with hardware. The software discussed herein may include script, batch, or other executable files. The software may be stored on a machine-readable or computer-readable storage medium, and is otherwise available to direct the operation of the computer system as described herein and claimed below. In one embodiment, the software uses a local or database memory to store media content, profile information and OLAP console application files. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

Although the described exemplary embodiments disclosed herein are directed to various computer devices and processes for programming media content, the present invention is not necessarily limited to the example embodiments which illustrate inventive aspects of the present invention that are applicable to a wide variety of technologies. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A method for programming media content on an aggregated media on-demand network, comprising:
modeling an aggregated media on-demand network by identifying a plurality of media-on-demand distribution channels that provide media content to a plurality of targeted consumers associated with a specified passion area and generating consumer profile information for the plurality of targeted consumers;
establishing distribution rights over the plurality of media-on-demand distribution channels for the aggregated media on-demand network;
measuring performance parameters for the aggregated media on-demand network; and
programming the aggregated media on-demand network with media content based on the consumer profile information for the plurality of targeted consumers, the performance parameters for the aggregated media on-demand network, and content profile information for the media content.

2. The method of claim 1 where modeling the aggregated media on-demand network comprises:
identifying a passion area of one or more market segments representing a target market demographic;
modeling the plurality of targeted consumers with a first standardized data template to provide a numerical representation of the consumer profile information for the plurality of targeted consumers;
modeling the plurality of media-on-demand distribution channels with a second standardized data template to provide a normalized numerical representation of the plurality of media-on-demand distribution channels; and
modeling a media content program with a third standardized data template to provide a numerical representation of the content profile information for the media content.

3. The method of claim 1, where establishing distribution rights comprises negotiating a business relationship which allows media content to be provided over the plurality of media-on-demand distribution channels.

4. The method of claim 1, where establishing distribution rights comprises of the creating new and unique channels of distribution that are aligned with the targeted audience and/or consumption requirements.

5. The method of claim 1, where establishing distribution rights comprises negotiating a business relationship which allows performance measurements to be acquired from the plurality of media-on-demand distribution channels.

6. The method of claim 1, where measuring performance parameters comprises instrumenting the plurality of media-on-demand distribution channels for statistics and transactional event data.

7. The method of claim 1, further comprising aligning the performance parameters measured from the aggregated media on-demand network along one or more predetermined dimensions for use in performing online analytical processing queries.

8. The method of claim 1, where programming the aggregated media on-demand network comprises selecting media content for distribution through the plurality of media-on-demand distribution channels by matching the content profile information for the media content with the consumer profile information for the plurality of targeted consumers and the performance parameters for the aggregated media on-demand network.

9. The method of claim 1, further comprising displaying in an analytics console the consumer profile information for the plurality of targeted consumers, the performance parameters for the aggregated media on-demand network, and content profile information for the media content.

10. A digital media programming system comprising:
a centralized network programming server communicatively coupled to a plurality of media outlet servers for actively programming digital media programs on a media-on-demand network comprising:
data storage device for storing:
one or more digital media programs,
content profile information for each digital media program specifying one or more characteristics of a targeted consumer of the digital media program,
network performance measurement data for each of the plurality of media outlet servers, and
consumer profile information for one or more targeted consumers;
a network modeling module that is configured to model a first media on-demand network by identifying a first distribution channel comprising a first group of media outlet servers that provide digital media programs to a first group of targeted consumers for a first consumer interest area;
a content programming module for programming the first group of media outlet servers in the first distribution channel with one or more digital media programs based on the model of the first media on-demand network.

11. The digital media programming system of claim 10, where the network modeling module models the first media on-demand network based on the consumer profile information for the first group of targeted consumers, the network performance measurement data, and content profile information for the one or more digital media programs.

12. The digital media programming system of claim 10, where the network modeling module comprises a first standardized data template to provide a numerical representation of the consumer profile information for one or more targeted consumers.

13. The digital media programming system of claim 10, where the network modeling module comprises a second standardized data template to provide a normalized numerical representation of the plurality of media outlet servers.

14. The digital media programming system of claim 10, where the network modeling module comprises a third standardized data template to provide a numerical representation of the content profile information for each digital media program.

15. The digital media programming system of claim 10, further comprising a data collection server which collects and records network performance measurement data in a normalized form from the plurality of media outlet servers for delivery to the centralized network programming server.

16. The digital media programming system of claim 10, where the network modeling module aligns network performance measurement data from the plurality of media outlet servers along one or more predetermined dimensions for use in performing online analytical processing queries.

17. The digital media programming system of claim 10, where the content programming module selects one or more digital media programs for distribution through the first group of media outlet servers in the first distribution channel by matching the content profile information for each digital media program with the consumer profile information for one or more targeted consumers and the network performance measurement data for each of the plurality.

18. A computer-implemented method for actively programming aggregated media on-demand networks, comprising:
identifying programming parameters comprising:
content profile information for each of one or more digital media programs specifying one or more characteristics of a consumer of the digital media program, and
consumer profile information for one or more consumers;
identifying one or more media-on-demand distribution channels from the plurality of media outlet servers based on the programming parameters, wherein each media-on-demand distribution channel comprises a group of media outlet servers which provide one or more digital media programs to one or more consumers associated with a specified consumer interest area; and
placing at least a first digital media program at a media-on-demand distribution channel for on-demand delivery to consumers who access the media-on-demand distribution channel, where the content profile information for the first digital media program matches at least in part the consumer profile information for the one or more consumers associated with the specified consumer interest area for the media-on-demand distribution channel.

19. The computer-implemented method of claim 18, where identifying programming parameters comprises identifying network performance measurement data for each of a plurality of media outlet servers.

20. The computer-implemented method of claim 19, where identifying one or more media-on-demand distribution channels comprises aligning network performance measurement data, content profile information and consumer profile information along one or more predetermined dimensions for use in performing online analytical processing queries.
